(19) United States
(12) Patent Application Publication
(10) Pub. No.: US 2009/0136820 A1
(43) Pub. Date: May 28, 2009

(54) PROTON EXCHANGE MEMBRANE AND MEMBRANE-ELECTRODE ASSEMBLY (MEA), METHOD FOR THEIR PRODUCTION AND FUEL CELL USING SAID MEMBRANE OR ASSEMBLY

(75) Inventors: Teresa Napolitano, Cimitile (NA) (IT); Nunzia Malagnino, Torre Annunziata (NA) (IT); Anna Borriello, Portici (NA) (IT); Giuseppe Mensitieri, Napoli (IT)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics S.r.l., Agrate Brianza (MI) (IT)

(21) Appl. No.: 12/129,863

(22) Filed: May 30, 2008

(30) Foreign Application Priority Data
May 31, 2007 (IT) MI2007A001113

(51) Int. Cl. H01M 8/10; C08J 5/22

(52) U.S. Cl. 429/33; 521/27

(57) ABSTRACT

A proton exchange membrane for electrolyte cells includes a polyelectrolyte polymer membrane comprising a sulfonated copolymer based on the following formula (I):

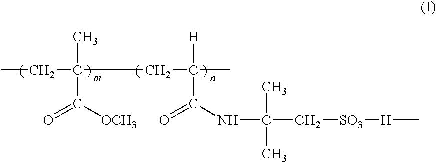

wherein n is an integer between 1 and 1,000,000, and m is an integer between 1 and 1,000,000. A membrane-electrode assembly includes such a membrane.

### FIELD OF THE INVENTION

The present invention relates to a proton exchange membrane and a membrane-electrode assembly (MEA) for electrochemical applications, and in particular, for Proton Exchange Membrane Fuel Cells (PEMFC).

The proton exchange membrane and the membrane-electrode assembly comprises sulfonated acrylamide copolymers for the PEMFCs. Moreover, the present invention is directed to a method for the production of such a membrane and a membrane-electrode assembly, as well to a fuel cell that uses the membrane or assembly.

### BACKGROUND OF THE INVENTION

Recently, research has been increasingly focusing on the development of alternative sustainable energy sources. As a consequences there is an ever increasing need for the development of technologies for the manufacturing of fuel cells (FC) on a large-scale. Fuel cells convert chemical energy into electrical energy through the electrochemical reaction between hydrogen and oxygen, which shows high energy efficiency.

Fuel cells are characterized by a very low environmental impact (their only waste product is water) and by an efficiency, under working conditions, which is twice that of an analogous combustion engine. Moreover, such devices function for as long as there is a fuel supply, thus having recharging requirements which are simpler compared to those of common batteries.

A fuel cell includes two electrodes, an anode and a cathode separated by an electrolyte. It uses a simple chemical process for combining hydrogen and oxygen to form water, thus producing an electrical current in the process.

In the case of hydrogen FCs or RHFCs (reformed methanol to Hydrogen Fuel Cell), the fuel is supplied to the anode, where the catalyst (generally platinum) is found. This favors the free dissociation reaction of the H2 into protons and electrons. The catalytic action at the anode is described by way of the following reactions:

H2+2Pt→2Pt—H

2Pt—H→2Pt+2H++2e−

Each hydrogen atom forms one proton and one electron. The proton crosses the electrolyte while the electron, after having traveled through the load connected to the fuel cell, reaches the cathode where a chemical reaction takes place involving the protons (hydrogen ions) and the atoms of oxygen present in the air. The product of this chemical reaction is water.

Overall, the electrochemical reactions which take place in a fuel cell include an oxidation half-reaction at the anode and a reduction half-reaction at the cathode:

oxidation half-reaction:

2H2→4H++4 e−

and reduction half-reaction:

O2+4H++4e−→2H2O

the overall reaction is the following:

2H2+O2→2H2O

Since the working principle of a fuel cell is based on chemical reactions and not on combustion processes, the emissions for this type of system are much more reduced as compared to those of the combustion processes. The only waste product of a fuel cell of this type, in fact, is water. In the case of natural gas fuel cells, carbon dioxide (CO2) is also produced, but in considerably lower quantities as compared to those that would be obtained by the burning of fuel.

Conventional fuel cells have been classified into phosphoric acid type fuel cells, molten carbonate type fuel cells, solid oxide type fuel cells, solid polymer type fuel cells, etc., depending on the type of electrolyte used. As a hydrogen source for the fuel cells, methanol, natural gases and the like can be used, which are converted or transformed into hydrogen in the fuel cells.

The currently known fuel cell classes are:

alkaline fuel cell (AFC);

sulfuric acid fuel cell (SAFC);

phosphoric acid fuel cell (PAFC);

solid oxide fuel cell (SOFC);

molten carbonate fuel cell (MCFC);

solid polymer fuel cell (SPFC); and

proton exchange membrane fuel cell (PEMFC).

In particular, for low-power applications having an overall power of the cell stack not greater than a hundred watts (cell phones, laptop computers) and in which the operating temperatures do not exceed 80° C., PEMFCs offer the advantage of having reduced system size, weight and above all, costs. Another advantage is fast cold start-up ability, even though they require expensive catalysts for the very purpose of activating the reactions at low temperatures.

A conventional PEM fuel cell includes a membrane-electrode assembly (MEA), and is interposed between two gas dispensers. The MEA includes a membrane hot pressed between two porous electrodes, including a catalytic layer and a gas diffusion layer.

FIG. 1 shows a schematic representation of a MEA for a proton exchange membrane fuel cell (PEMFC). In the cell, the polyelectrolyte membrane, including a solid polymer layer, has the function of electronically isolating the anode and cathode and allowing the protons which have formed at the anode to pass through it. This is while the electrons are made available to an external load so that they can then be used up in combination with the protons once they reach the cathode.

As for the electrodes, their function is that of favoring the reaction between the reagent and the electrolyte, without being used up or corroded themselves, and of bringing into contact the three gaseous fuel, electrolyte and electrode phases.

The electrodes include a catalytic layer in direct contact with the membrane and a diffusion layer. They are made by depositing, on a carbon porous conductive fiber, the catalyst in particulate form supported by electronic transport phases, typically Carbon Black (CB).

As for the catalyst, the anode electrode and the cathode electrode are preferably made with metals of a different nature. Preferred catalytic metals for the cathode electrode are platinum and alloys of platinum with cobalt or chromium. For the anode electrode, preferred metals include ruthenium, rhodium, iridium, palladium, platinum and alloys of such metals (U.S. patent application no. 2002/0068213 to Kaiser et al.)

The catalytic layer also contains the proton transport phase, which enables the protons, generated at the anode, to reach the electrolyte membrane. Such a phase generally includes the same material as the membrane so as to favor the assembly. The catalytic layer must, moreover, be suitably porous in order to ensure the flow of fuel to the anode and the flow of oxygen to the cathode.

Currently, conventional MEAs are made using Nafion® as a polymer electrolyte (electrolyte membrane) while the electrodes are obtained from a Nafion® ink in solution, and platinum supported on Carbon Black deposited on carbon paper. At present, the Nafion®-type membranes available from DuPont and the like are the most popular materials on the market.

The Nafion®-type membranes contain perfluorinated resins having a perfluoroalkylether side chain having a sulfonic acid group at its end. Even though such membranes satisfy many of the above-mentioned requirements, they have some disadvantages. These disadvantages mainly include the high costs of the materials forming the membranes. Additionally, the membranes exhibit an unacceptable methanol exchange and water transport rate, and exhibit totally unsuitable properties above 100° C., a very important emerging requirement for which the use of such membranes is of interest.

The polyelectrolyte membrane is the key component of the MEA, and thus of the fuel cell. Recently, in the search for a possible polyelectrolyte membrane which could substitute Nafion®, new 2-acrylamide-2-methyl-1-propanesulfonic acid monomer polymeric membranes have been developed (U.S. Pat. No. 4,174,152; U.S. Pat No. 4,375,318; U.S. Pat. No. 4,478,991; Walker, ARL-TR-2731, May 2002; and Karlsson et al., (2002) Macromol. Chem. Phys., 203, 686-694).

In particular, Charles W. Walzer Jr., U.S. Army Research Laboratory, has developed a 2-acrylamide-2-methyl-1-propanesulfonic acid (AMPS) and 2-hydroxyethyl methacrylate (HEMA) membrane. The copolymer, in hydrated conditions, absorbs more water compared to Nafion® 117 but is less capable of retaining it during drying at room temperature.

Films composed of 4% by weight of AMPS and 96% by weight of HEMA have, at room temperature, a proton conductivity of 0.029 S cm−1 while it is of 0.06 S cm−1 at 80° C. (Karlsson et al., (2002) Macromol. Chem. Phys., 203, 686-694).

Therefore, there is a need for providing a membrane and a membrane-electrode assembly which overcome the drawbacks of the prior art described above, and which are thus not only inexpensive, easy to produce, and a smaller size and weight but also highly conductive and efficient.

### SUMMARY OF THE INVENTION

In view of the foregoing background, an object of the present invention is to provide a membrane and a membrane-electrode assembly for electrochemical applications, and in particular, for fuel cells (FC).

This and other objects, advantages and features in accordance with the present invention are provided by a proton exchange membrane for electrolyte fuel cells (PEMFC), wherein the membrane comprises a polyelectrolyte polymer membrane comprising a sulfonated copolymer of the following formula (I):

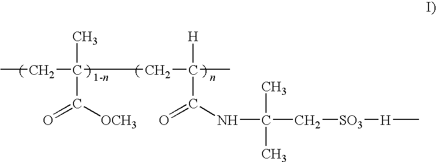

in which n is an integer between 1 and 1,000,000, and preferably between 1 and 1,000, and still more preferably between 1 and 50; and m is an integer between 1 and 1,000,000, and preferably between 1 and 1,000, and still more preferably between 1 and 50.

A membrane-electrode assembly for electrolyte cells of the proton exchange membrane type (PEMFC) comprises two electrodes and an electrolyte membrane sandwiched between the two electrodes, wherein the membrane is a polyelectrolyte polymer membrane comprising a sulfonated copolymer of the following formula (I):

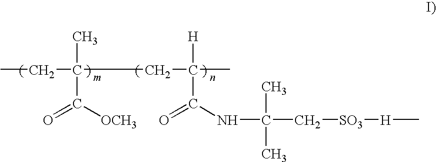

in which n is an integer between 1 and 1,000,000, and preferably between 1 and 1,000, and still more preferably between 1 and 50; and m is an integer between 1 and 1,000,000, and preferably between 1 and 1,000, and still more preferably between 1 and 50.

The membrane may be in the form of a film comprising the sulfonated polymer, and the film may have a thickness between 10 and 200 μm. The electrodes of the membrane-electrode assembly for electrolyte cells may comprise a sulfonated copolymer (I) as specified above.

The sulfurated copolymers may be obtained from an alkyl acrylate and from an acrylamide alkyl sulfonic acid. The alkyls may be linear or branched, and each may have a number of carbon atoms (C) between 1 and 100, and preferably between 1 and 50, and still more preferably between 1 and 10.

The alkyl acrylate may be chosen from the group comprising butyl methacrylate (BMA), ethyl methacrylate (EMA), isopropyl methacrylate (PMA), and methyl methacrylate (MMA). The group methyl methacrylate (MMA) may preferably be chosen.

The acrylamide alkyl sulfonic acid may be chosen from the group comprising 2-acrylamide-2-methyl-1-butanesulfonic acid, 2-acrylamide-2-methyl-1-ethanesulfonic acid, 2-acrylamide-2-ethyl-1-propanesulfonic acid, 2-acrylamide-2-butyl-1-propanesulfonic acid, and 2-acrylamide-2-methyl-1-propanesulfonic acid. The group 2-acrylamide-2-methyl-1-propanesulfonic acid (AMPS) may preferably be chosen.

The alkyl acrylate and the acrylamide alkyl sulfonic acid may be found in molar ratios that may be variable between 95:5 and 60:40, and preferably 80:20. The electrodes may comprise, in addition to the copolymer, Carbon Black (CB) and Pt.

The copolymer of the electrolyte membrane may be chosen based on the fact that the sulfonated alkyl acids, in particular AMPS, exhibit good chemical stability and proton conductivity characteristics, entirely comparable to those of the prior art available on the market. Moreover, they advantageous exhibit characteristics such as simplicity and the low cost of their production and of the materials used in their production. The production method also has a low environmental impact, since it involves the use of harmless reaction reagents and intermediates.

By making not only the electrolyte membrane, but also the polymer electrodes with the sulfonated acrylamide polymers, a MEA may be obtained having the desired characteristics. The membrane-electrode assemblies may exhibit long-term stability and considerable ion exchange capacity characteristics, and are therefore suitable for use in hydrogen fuel cells.

By making both the electrolyte membrane and the electrodes with the polymers, an improved membrane-electrode assembly may be attained in which the contact resistance between membrane and electrode is reduced, which in turn determines an improvement of the stability and efficiency characteristics of the present invention as well as of the entire fuel cell.

Another aspect is directed to a method for producing a membrane for a membrane-electrode assembly for electrolyte cells of the PEMFC type. The method may comprise the steps of:

a) Reacting an alkyl acrylate and an acrylamide alkyl sulfonic acid in solution, the alkyls being linear or branched and each having a number of carbon atoms (C) between 1 and 100, and preferably between 1 and 50, and still more preferably between 1 and 10, in conditions suitable for obtaining a sulfonated copolymer, in the presence of a radical initiator and/or by light energy, preferably UV;

b) Precipitating the sulfonated copolymer by the addition of a precipitating agent to the solution;

c) Separating the sulfonated copolymer from the solution and re-dissolving it in a suitable solvent, obtaining a new solution comprising the sulfonated copolymer; and

d) Treating the new solution so as to form a film comprising the sulfonated polymer.

The alkyl acrylate may be chosen from the group comprising butyl methacrylate (BMA), ethyl methacrylate (EMA), isopropyl methacrylate (PMA), and methyl methacrylate (MMA). The group methyl methacrylate (MMA) may preferably be chosen.

The acrylamide alkyl sulfonic acid may be chosen from the group comprising 2-acrylamide-2-methyl-1-butanesulfonic acid, 2-acrylamide-2-methyl-1-ethanesulfonic acid, 2-acrylamide-2-ethyl-1-propanesulfonic acid, 2-acrylamide-2-butyl-1-propanesulfonic acid, and 2-acrylamide-2-methyl-1-propanesulfonic acid. The group 2-acrylamide-2-methyl-1-propanesulfonic acid (AMPS) may preferably be chosen.

The alkyl acrylate and the acrylamide alkyl sulfonic acid may be found in molar ratios variable between 95:5 and 60:40. The molar ratio between the alkyl acrylate and the acrylamide alkyl sulfonic acid may be 80:20.

The reaction of step a) may be carried out at a temperature between 50 and 70° C. for 24-48 hours. The temperature of the reaction of step a) may be 60° C. and the reaction duration may be 36 hours.

The radical initiator may be chosen from the group which comprises peroxides and azo-compounds, and more preferably 2,2′-azobis(isobutyronitrile). The precipitating agent may be an ether, and preferably ethyl ether ((C₂H₅)₂O).

The reaction of step a) may be carried out in a solvent. The solvent may be an alcohol, and more preferably methanol (CH₃OH).

The separation of the sulfonated copolymer from the reaction solution may be carried out in a conventional manner, for example, by centrifugation or filtration.

The method may comprise a further washing step of the sulfonated copolymer separated from the reaction solution, for a period of time sufficient for eliminating the excess of unreacted monomer. The washing step may be carried out in distilled water for 5-12 days, and preferably seven days.

The method may further comprise a drying step of the sulfonated copolymer separated from the reaction solution at a temperature between 30 and 70° C. Such drying can be carried out under vacuum or at atmospheric pressure, and preferably under vacuum. The drying step may be carried out at 50° C. under vacuum. The re-dissolving of the sulfonated copolymer step may be carried out at 50-70° C. in methanol as solvent.

The film comprising the sulfonated copolymer may be obtained by depositing the new solution onto a substrate, and preferably on a Teflon disc, and removing the solvent. The film may have a thickness of about 80 μm.

An important advantage of the present invention is that of being able to control the degree of swelling of the copolymer based on the ratio of the two monomers. By varying the ratio between the two monomers, it may be possible to adjust the extent of swelling of the copolymer membrane, and thus that of the MEA, depending on the required characteristics. In particular, by increasing the quantity of the AMPS monomer, that is, the monomer containing the sulfonic group, copolymers may be obtained having greater water absorption capacities given the greater percentage of the more hydrophilic group.

It may be necessary to obtain a good swelling of the membrane in order to increase its conductivity. Optimal swelling values are those in which the proton conductivity of the membrane may be maximized, within the spatial constraints dictated by the device on which they are applied.

### BRIEF DESCRIPTION OF THE DRAWINGS

The characteristics and advantages of the membrane and membrane-electrode assembly in accordance with the present invention will be more evident from the following description, given through non-limiting examples with reference to the attached drawings. In the drawings:

FIG. 1 shows a schematic representation of a MEA in accordance with the present invention;

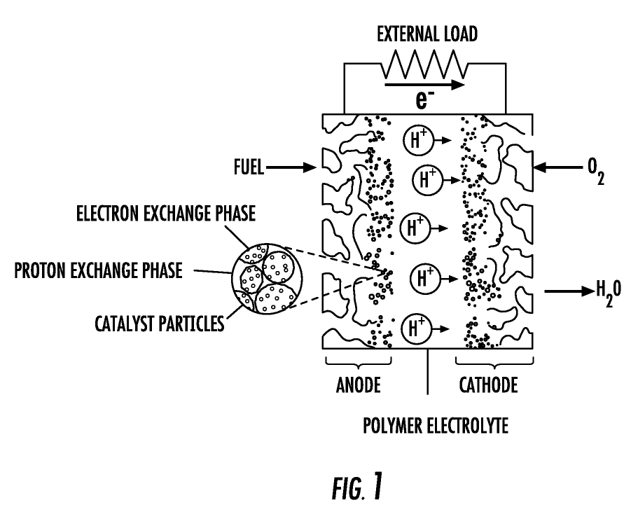

FIG. 2 shows a thermogram (obtained using a Differential Scanning Calorimeter, DSC) of a PMMA-co-AMPS copolymer containing 12, 15 and 18% AMPS in accordance with the present invention;

FIG. 3 shows a thermogravimetric curve (obtained by thermogravimetric analysis, TGA) of the PMMA-co-AMPS copolymer containing 18% AMPS in accordance with the present invention; and

FIG. 4 shows a proton conductivity of the PMMA-co-AMPS copolymer membrane containing 18% AMPS at 100% relative humidity as a function of the temperature in accordance with the present invention.

### DETAILED DESCRIPTION OF THE PREFERRED EMBODIMENTS

The following description will be in reference to the preparation of the membrane-electrode assembly (MEA) in accordance with the present invention.

### Examples 1-9

The experimental tests at different molar ratios of MMA and AMPS are described in detail below, as summarized in TABLE 1.

TABLE 1
Summary of examples 1-7

| | | | | Initiator | |
|---|---|---|---|---|---|
| | | MMA | AMPS | and | Temperature |
| | Sample | (ml) | (g) | methanol | and time |
| Example 1 | 10% AMPS | 4.4 | 0.943 | 0.025 g & | 60° C. & 24 h |
| | | | | 20 ml | |
| Example 2 | 12% AMPS | 4.18 | 1.1 | 0.025 g & | 60° C. & 24 h |
| | | | | 20 ml | |
| Example 3 | 15% AMPS | 3.66 | 1.337 | 0.025 g & | 60° C. & 24 h |
| | | | | 20 ml | |
| Example 4 | 18% AMPS | 4.23 | 0.83 | 0. 025 g & | 60° C. & 24 h |
| | | | | 20 ml | |
| Example 5 | 20% AMPS | 3.52 | 1.71 | 0.025 g & | 60° C. & 24 h |
| | | | | 20 ml | |
| Example 6 | 20% AMPS | 3.52 | 1.71 | 0.025 g & | 60° C. & 28 h |
| | | | | 20 ml | |
| Example 7 | 30% AMPS | 3.17 | 2.046 | 0.025 g & | 60° C. & 24 h |
| | | | | 20 ml | |

### Example 1

To synthesize a copolymer containing 10% by weight of AMPS, a solution of 2-acrylamide-2-methyl-1-propanesulfonic acid (AMPS) in methanol is prepared by dissolving, at a temperature of 60° C. and with magnetic stirring, 0.943 g of AMPS acid in 20 ml of methanol (CH3OH); subsequently 4.4 ml of MMA are added, and finally 0.025 g of AIBN. The solution is maintained under stirring for 24 hours, still at a temperature of 60° C., to allow the copolymerization reaction to take place; after the synthesis, the copolymer is made to precipitate by adding an ether. A series of washings in distilled water are then carried out to remove the unreacted monomer. The obtained solution is filtered and the copolymer is dried at 50° C. under vacuum. The copolymer is re-dissolved at 60° C. in methanol and the resulting solution is deposited on a Teflon disc, and the solvent is removed, obtaining an electrolyte membrane in the form of a film having a thickness of approximately 80 μm.

### Example 2

To synthesize a copolymer containing 12% by weight of AMPS, a solution of AMPS acid in methanol is prepared by dissolving, at a temperature of 60° C. and with magnetic stirring, 1.1 g of AMPS acid in 20 ml of CH3OH; subsequently 4.18 ml of MMA are added, and finally 0.025 g of AIBN are added.

The solution is maintained under stirring for 25 hours, still at a temperature of 60° C. to allow the copolymerization reaction to take place; after the synthesis, the copolymer is made to precipitate by adding an ether. A series of washings are then carried out in distilled water, at 70° C. temperature, to remove the unreacted monomer. The solution obtained is filtered and the copolymer dried at 50° C. under vacuum. The copolymer is re-dissolved at 60° C. in methanol and the resulting solution is deposited on a Teflon disc, and the solvent is removed, obtaining an electrolyte membrane in the form of a film having a thickness of approximately 80 μm.

### Example 3

To synthesize a copolymer containing 15% by weight of AMPS, a solution of AMPS acid in methanol is prepared by dissolving, at a temperature of 60° C. and with magnetic stirring, 1.337 g of AMPS acid in 20 ml of CH3OH; subsequently 3.66 ml of MMA are added and finally 0.025 g of AIBN are added. The solution is maintained under stirring for 24 hours, still at a temperature of 60° C. to cause the copolymerization reaction to take place; after the synthesis, the copolymer is made to precipitate by adding an ether. A series of washings are then carried out in distilled water, at a temperature of 70° C., to remove the unreacted monomer. The obtained solution is filtered and the copolymer is dried at 50° C. under vacuum. The copolymer is re-dissolved at 60° C. in methanol and the resulting solution is deposited on a Teflon disc, and the solvent is removed, obtaining an electrolyte membrane in the form of a film having a thickness of approximately 80 μm.

### Example 4

To synthesize a copolymer containing 18% by weight of AMPS, a solution of AMPS acid in methanol is prepared by dissolving, at a temperature of 60° C. and with magnetic stirring, 1.337 g of AMPS acid in 20 ml of CH3OH; subsequently 3.66 ml of MMA and finally 0.025 g of AIBN are added. The solution is maintained under stirring for 24 hours, still at a temperature of 60° C. to cause the copolymerization reaction to take place; after the synthesis, the copolymer is made to precipitate by adding an ether. A series of washings are then carried out in distilled water, at a temperature of 70° C., to remove the unreacted monomer. The solution obtained is filtered and the copolymer is dried at 50° C. under vacuum. The copolymer is re-dissolved at 60° C. in methanol and the resulting solution is deposited on a Teflon disc, and the solvent is removed, obtaining an electrolyte membrane in the form of a film having a thickness of approximately 80 μm.

### Example 5

To synthesize a copolymer containing 20% by weight of AMPS, a solution of AMPS acid in methanol is prepared by dissolving, at a temperature of 60° C. and with magnetic stirring 1.337 g of AMPS acid in 20 ml of CH3OH; subsequently 3.66 ml of MMA and finally 0.025 g of AIBN are added. The solution is maintained under stirring for 24 hours, still at a temperature of 602 C. to cause the copolymerization reaction to take place; after the synthesis, the copolymer is made to precipitate by adding an ether. A series of washings are then carried out in distilled water, at a temperature of 70° C., to remove the unreacted monomer. The solution obtained is filtered and the copolymer is dried at 60° C. under vacuum. The copolymer is re-dissolved at 60° C. in methanol and the resulting solution is deposited on a Teflon disc, and the solvent is removed, obtaining an electrolyte membrane in the form of a film having a thickness of approximately 80 μm.

### Example 6

To synthesize a copolymer containing 20% by weight of AMPS, a solution of AMPS acid in methanol is prepared by dissolving, at a temperature of 60° C. and with magnetic stirring, 1.337 g of AMPS acid in 20 ml of CH3OH; subsequently 3.66 ml of MMA and finally 0.025 g of AIBN are added. The solution is maintained under stirring for 28 hours, still at a temperature of 60° C. so to cause the copolymerization reaction to take place; after the synthesis, the copolymer is made to precipitate by adding an ether. A series of washings are then carried out in distilled water, at a temperature of 70° C., to remove the unreacted monomer. The solution obtained is filtered and the copolymer is dried at 60° C. under vacuum. The copolymer is re-dissolved at 60° C. in methanol and the resulting solution is deposited on a Teflon disc, and the solvent is removed, obtaining an electrolyte membrane in the form of a film a thickness of approximately 80 μm.

### Example 7

To synthesize a copolymer containing 30% by weight of AMPS, a solution of AMPS acid in methanol is prepared by dissolving, at a temperature of 60° C. and with magnetic stirring, 1.337 g of AMPS acid in 20 ml of CH3OH; subsequently 3.66 ml of MMA and finally 0.025 g of AIBN are added. The solution is maintained under stirring for 24 hours, still at a temperature of 60° C. to cause the copolymerization reaction to take place; after the synthesis, the copolymer is made to precipitate by adding an ether. A series of washings are then carried out in distilled water, at a temperature of 70° C., to remove the unreacted monomer. The solution obtained is filtered and the copolymer is dried at 50° C. under vacuum. The copolymer is re-dissolved at 60° C. in methanol and the resulting solution is deposited on a Teflon disc, and the solvent is removed, obtaining an electrolyte membrane in the form of a film having a thickness of approximately 80 μm.

Chemical-physical characterization will now be discussed. The chemical-physical properties of the copolymer membranes, such as the glass transition temperature (Tg), melting temperature (Tm), crystallization temperature (Tc) and the degradation temperature, were determined by calorimetric and thermogravimetric analysis. To conduct the characterizations, a TA Instrument 2920 Differential Scanning Calorimeter (DSC, Differential Scanning Calorimetry) and a TA Instrument 2950 Thermogravimetric Balance (TGA, Thermogravimetric Analysis) equipped with pure nitrogen flow were used.

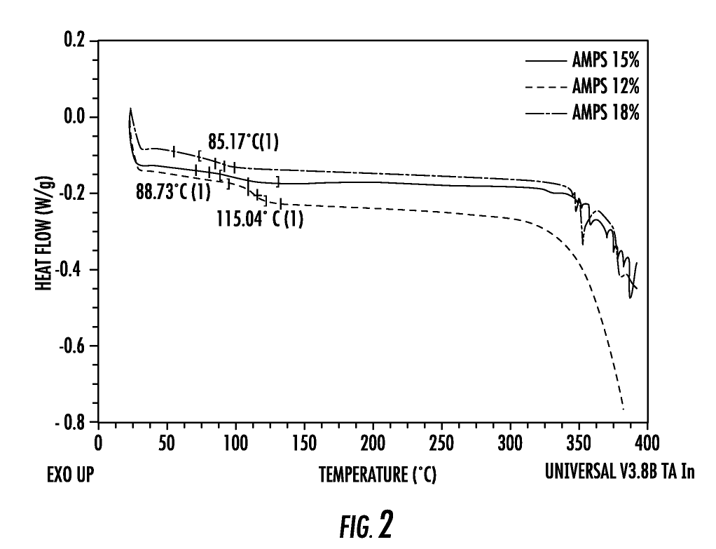

FIG. 2 illustrates the thermogram of three copolymer membrane samples containing 12%, 15% and 18% AMPS, respectively of 7.99 mg, 9.5 mg and 8.88 mg in weight in which the Tgs of the membranes are clearly shown. Such values are positioned in the temperature range falling between the glass transition temperature of the polyacrylamide-2-methyl-1-propanesulfonic acid (PAMPSA), 75° C., and that of the polymethyl methacrylate (PMMA), 125° C. In particular, it can be observed that the sample containing 12% AMPS by weight has a glass transition temperature of 115.71° C., and closer to that of the PMMA while the Tgs of the samples containing 15% and 18% AMPS by weight are respectively 89° C. and 85° C., and closer to that of the PAMPSA.

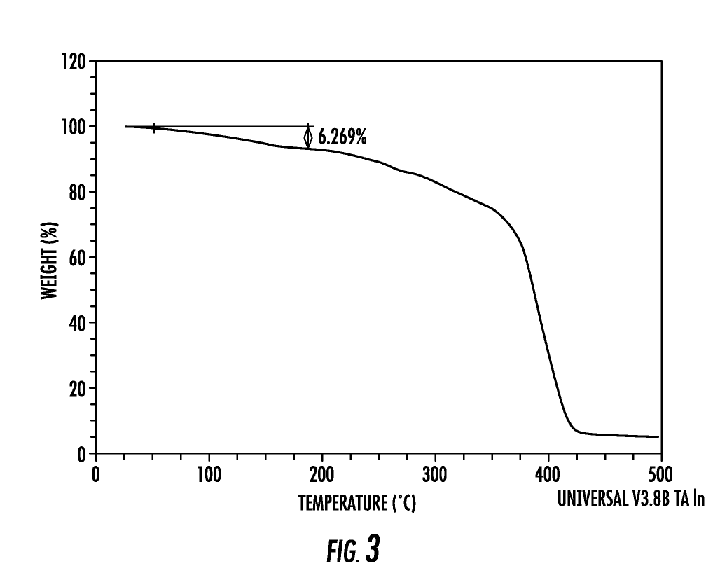

FIG. 3 illustrates the thermogravimetric curve of the copolymer sample containing 18% AMPS by weight. The scanning was conducted from 30° C. to 500° C. at the speed of 10° C./min in nitrogen, on a sample of 15.975 mg in weight, respectively. A first decrease in weight is observed in the 50-150° C. interval, corresponding to the removal of the water absorbed by the membrane, and then at about 380° C. polymer degradation takes place. The thermogravimetric curves of the other samples have a similar behavior and for that reason have not been shown.

Water absorption measurements will now be discussed. The measurements of water absorption on the copolymer membranes were conducted according to the following procedure.

The membranes were soaked in distilled water at room temperature for 24 hours. Subsequently, the water on the surface of the membranes was dried and their weight measurements W1(g) were taken. Finally, the membranes were dried at 120° C. for 4 hours and their weight measurements W2(g) were taken. The water content C(%) of the membrane was calculated according to the following expression:

100 C(%)=[(W1−W2)/W1]×100

TABLE 2 provides the results of the water content of the laboratory-prepared membranes. It is observed that the water content increases with increasing percentage by weight of AMPS used in the copolymerization step. For comparison purposes, the water content of a Nafion® 117 commercial membrane is also given in TABLE 2, such value having been obtained by the same procedure used for the membranes.

TABLE 2
Water content of the PMMA-co-AMPS membranes

| Sample | Water content (%) |
|---|---|
| 12% AMPS | 34 |
| 15% AMPS | 64 |
| 18% AMPS | 77 |
| Nafion ® 117 | 24 |

Proton conductivity measurements of the polyelectrolyte membrane will now be discussed. The proton conductivity of the membranes was obtained by measuring the lateral resistance of the samples with a four point measurement, by the impedance spectroscopy technique in galvanostatic mode (Summer et al. J. Electrochem. Soc 145, 107-110 (1998)).

The sample was placed in a Teflon sample holder purposely designed with four platinum electrodes (four points): two more external and flat, through which the current was passed, and two more internal and threadlike, at the ends of which the drop in potential was measured. The more internal electrodes have a diameter of 0.8 mm and are at a distance of 0.42 cm from each other.

The impedance measurements were conducted by using the Solartron SI 1280B electrochemical impedance analyzer. The instrument was used in galvanostatic mode with 0.01 mA amplitude alternating current and frequency in the range of 0.1-20,000 Hz. The values of the impedance modulus and phase as a function of the frequency are shown in the Bode diagrams, and the resistance of the samples was extrapolated by considering the impedance modulus value in the frequency range in which the phase is approximately zero. The proton conductivity value, then, was obtained according to the following equation

σ=L/R×A

where R is the resistance value extrapolated from the Bode diagrams in the manner described, L is the distance between the two internal electrodes and A is the sample cross-section (Doyle et al. J. Membrane Science 184, 257-273 (2001)).

Given the critical dependency of the proton conductivity on the temperature and relative humidity, all impedance measurements were conducted by placing the sample holder in a thermostated glass cell containing bidistilled water, to create a controlled temperature environment at 100% relative humidity. The membrane samples were cut into strips of 1.0 cm×2.0 cm in size and were maintained in bidistilled water at room temperature for at least 24 hours prior to characterization.

TABLE 3 provides the conductivity values both for the copolymer membranes, produced with different composition, and for a Nafion® 117 sample. These values were obtained by the respective impedance measurements, conducted in the following manner: the sample contained in the sample holder was placed in the glass cell at a temperature of 31.5° C. until it was soaked in bidistilled water; when thermal equilibrium had been achieved, the sample holder, while remaining in the cell, was extracted from the water and the measurement was made.

TABLE 3
Proton conductivity of the PMMA-co-AMPS membranes

| | Proton conductivity T = 31.5° C., |
|---|---|
| Sample | RH = 100% (mS/cm) |
| 12% AMPS | 3 ± 1 |
| 15% AMPS | 11 ± 2 |
| 18% AMPS | 23 ± 2 |
| Nafion ® 117 | 60 ± 5 |

It can be observed that, as expected, the proton conductivity increases with an increasing percentage of AMPS, which is the polymer containing the sulfonic group.

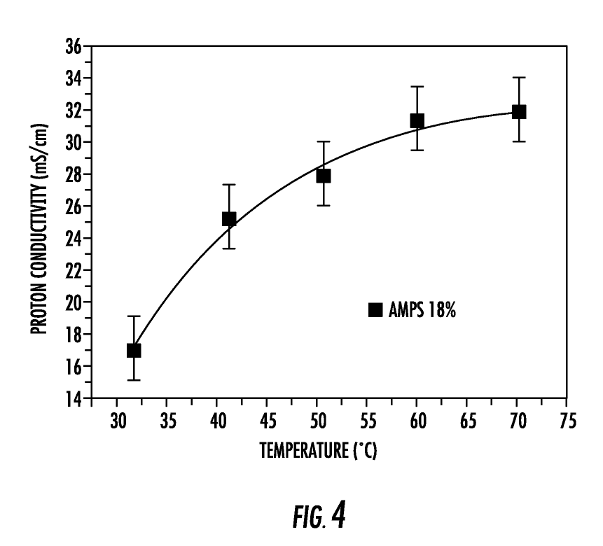

FIG. 4 illustrates the graph of the proton conductivity as a function of the temperature for the most conductive sample, i.e., that containing 18% AMPS. These values were obtained from the respective impedance measurements, conducted in the following manner: the sample was placed in the sample holder after having been dried on its surface.

Then, it was placed in the glass cell where a 100% humidity environment was created at various temperatures; finally, a sequence of measurements was made for each temperature, until the impedance was constant, confirming that the sample had reached equilibrium with the surrounding environment.

As expected, the proton conductivity increases with increasing temperature, in particular between 30° C. and 50° C., the most relevant range for portable fuel cell applications. Moreover, it can be observed that the conductivity value (17±2 mS/cm) corresponding to the temperature of 31.5° C. obtained at 100% relative humidity in vapor phase is lower than that previously reported for the same sample at the same temperature, but at 100% relative humidity in a liquid phase. This confirms that the AMPS copolymers in a vapor phase tend to more readily release water.

### Example 8

Preparation of electrodes with sulfonated copolymers will now be discussed. The new AMPS-PMMA electrodes can be made by re-dissolving the copolymer, with the selected percentage of AMPS, at 60° C. in methanol. To the solution thus obtained, the catalyst powder is added, supported on Carbon Black, for example 20% Pt on CB (Quintech). Finally, the electrocatalytic ink is deposited directly on Toray carbon paper (Quintech).

In making the electrodes, two parameters are of fundamental importance: the ratio of the ionomer phase to the catalyst powder on CB (T/C) and the ink deposition technique (Vielstich et al. (2003) In Handbook of Fuel Cell, Vol. 3, 549-551, Wiley). The right quantity of ionomer phase and its distribution in the catalytic layer is midway between the minimum electrode resistance and the maximum contact of the ionomer phase with the Pt particles as well as the maximum access of the reagents to the catalyst through the pores of the electrocatalytic layer. The optimal content of ionomer phase is about 30% by weight (Wilson and Gottesfeld (1992), J. Appl. Electrochem., 22, 1, Wilson and Gottesfeld (1992), J. Electrochem. Soc., 139, L28).

Regarding the manufacturing technique, there are various methods for depositing the electrocatalytic ink on carbon paper, such as: atomized spray coating, slot or roll coating, screen printing, liquid nozzle applicators, etc. (Vielstich et al. (2003) In Handbook of Fuel Cell, Vol. 3, 549-551, Wiley, U.S. Pat. No. 5,843,519).

### Example 9

MEA production will now be discussed. To make the new copolymer MEAs, a hot assembly process in water was used, due to the nature of the polyelectrolyte membrane.

The AMPS-PMMA membranes were assembled with the standard electrodes of Pt on CB (1 mg/cm2 Pt loading, 20 wt. % Pt/Vulcan XC72 on Toray-paper, Quintech), using a distilled water bath at a temperature of 70° C. at a pressure of the kPa order for 24 h. This assembly method, known as steam-pressing, is used to prevent the polyelectrolyte membrane from possibly cracking. The MEAs made were tested in a hydrogen and oxygen fuel cell, which fuels had been previously produced by water hydrolysis, using the same fuel cell.

A PEMFC involves the use of a protonically-conductive membrane as electrolyte. The polyelectrolyte membrane is an acid electrolyte in which the negative ions are immobilized in the polymer matrix and must remain hydrated in order to conduct the protons. Consequently, the operating temperature of the fuel cells needs to be lower than the boiling point of water.

The main advantages linked to the use of solid polymer electrolytes concern the high power densities attainable, and the absence of stability and corrosion problems in using liquid electrolytes.

The polymer electrolyte fuel cells are a low environmental impact energy source and are preferable due to their relative low operating temperature, high efficiency and, with respect to manufacture, the low cost of the materials. The most interesting prospects for large scale applications of the fuel cells are in the development of power generators for portable power sources.

In the last few years, considerable progress has been made in the development of portable electronic devices. Despite that, batteries represent the only possibility for devices which require more than 100 W of electrical power. The main limit of the batteries for applications such as cell phones and computer laptops are given by the weight and the volume together with the low current density which limits the working time before recharging is required. Changing the batteries is also an environmental problem. In fact, the materials they are made of cannot be recycled.

The methanol or hydrogen fuel cells are capable of providing an energy density which is 30 times higher than that of the current Ni/Cd batteries. In light of the development of power generation systems for portable devices, to substitute the batteries, the sulfonated acrylic copolymer polyelectrolyte membranes represent a valid alternative to the commercial Nafion® ones currently used in hydrogen fuel cells. In fact, the membranes developed in the present work have comparable performances, from a proton conductivity standpoint, to the commercial ones, but have lower costs due both to the materials used and to the manufacturing process. The manufacturing method has, in fact, a low environment impact, since it involves the use of reaction reagents and intermediates which are not harmful, and requires a lower number of manufacturing steps.

1-39. (canceled)

40. An article comprising:
a polyelectrolyte polymer membrane comprising a sulfonated copolymer based on formula (I): 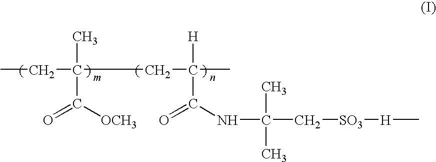
where n is an integer between 1 and 1,000,000; and m is an integer between 1 and 1,000,000.

41. The article according to claim 40, wherein n is an integer between 1 and 1,000; and m is an integer between 1 and 1,000.

42. The article according to claim 40, wherein said polyelectrolyte polymer membrane is configured as a film comprising said sulfonated copolymer.

43. The article according to claim 40, wherein said sulfonated copolymers are obtained from an alkyl acrylate and an acrylamide alkyl sulfonic acid, with said alkyls being linear or branched and each having a number of carbon atoms between 1 and 100.

44. The article according to claim 43, wherein said alkyl acrylate is selected from a group consisting of butyl methacrylate (BMA), ethyl methacrylate (EMA), isopropyl methacrylate (PMA), and methyl methacrylate (MMA).

45. The article according to claim 43, wherein said acrylamide alkyl sulfonic acid is selected from a group consisting of 2-acrylamide-2-methyl-1-butanesulfonic acid, 2-acrylamide-2-methyl-1-ethanesulfonic acid, 2-acrylamide-2-ethyl-1-propanesulfonic acid, 2-acrylamide-2-butyl-1-propanesulfonic acid, and 2-acrylamide-2-methyl-1-propanesulfonic acid.

46. The article according to claim 43, wherein said alkyl acrylate and said acrylamide alkyl sulfonic acid are in molar ratios varying between 95:5 and 60:40.

47. The article according to claim 43, wherein said alkyl acrylate and said acrylamide alkyl sulfonic acid are in a molar ratio of 80:20.

48. A fuel cell comprising:
at least one pair of electrodes; and
a proton exchange polyelectrolyte polymer membrane between adjacent electrodes and comprising a sulfonated copolymer based on formula (I): 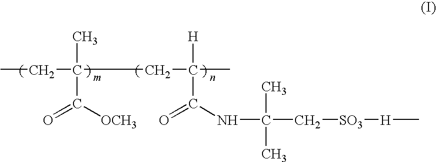
where n is an integer between 1 and 1,000,000; and m is an integer between 1 and 1,000,000.

49. The fuel cell according to claim 48 wherein n is an integer between 1 and 1,000; and m is an integer between 1 and 1,000.

50. The fuel cell according to claim 48, wherein said polyelectrolyte polymer membrane is configured as a film comprising said sulfonated copolymer.

51. The fuel cell according to claim 48, wherein said sulfonated copolymers are obtained from an alkyl acrylate and an acrylamide alkyl sulfonic acid, with said alkyls being linear or branched and each having a number of carbon atoms between 1 and 100.

52. The fuel cell according to claim 48, wherein each electrode comprises a sulfonated copolymer based on the formula (I).

53. The fuel cell according to claim 52, wherein each electrode further comprises Carbon Black (CB) and Pt.

54. A method for producing a polyelectrolyte polymer membrane comprising a sulfonated copolymer based on formula (I): 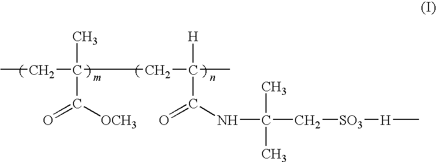
where n is an integer between 1 and 1,000,000; and m is an integer between 1 to 1,000,000, the method comprising:
a) reacting an alkyl acrylate and an acrylamide alkyl sulfonic acid in a solution, the alkyls being linear or branched and each having a number of carbon (C) atoms between 1 and 100, for obtaining a sulfonated copolymer, in the presence of at least one of a radical initiator and light energy;
b) precipitating the sulfonated copolymer by the addition of a precipitating agent to the solution;
c) separating the sulfonated copolymer from the solution and re-dissolving it in a solvent, obtaining a new solution comprising the sulfonated copolymer; and
d) treating the new solution to form a film comprising the sulfonated copolymer.

55. The method according to claim 54, wherein the alkyl acrylate and acrylamide alkyl sulfonic acid are in molar ratios varying between 95:5 and 60:40.

56. The method according to claim 55, wherein the alkyl acrylate and acrylamide alkyl sulfonic acid are in a molar ratio of 80:20.

57. The method according to claim 54, wherein the reaction of step a) is carried out at a temperature between 50 and 70° C. for 24 to 48 hours.

58. The method according to claim 57, wherein the temperature of the reaction of step a) is 60° C. and the reaction duration is 36 hours.

59. The method according to claim 54, wherein the radical initiator comprises at least one of peroxides and azo-compounds.

60. The method according to claim 59 wherein said radical initiator is 2,2′-azobis (isobutyronitrile).

61. The method according to claim 54, wherein the precipitating agent comprises ether.

62. The method according to claim 61, wherein the precipitating agent comprises an ethyl ether.

63. The method according to claim 54, wherein the reaction of step a) is carried out in a solvent.

64. The method according to claim 63, wherein the solvent comprises alcohol.

65. The method according to claim 64, wherein the solvent comprises methanol.

66. The method according to claim 54, further comprising washing the sulfonated copolymer separated from the reaction solution to remove the excess unreacted monomer.

67. The method according to claim 66, wherein the washing step is carried out in distilled water for 5 to 12 days.

68. The method according to claim 54, further comprising drying the sulfonated copolymer separated from the reaction solution at a temperature between 30 and 70° C.

69. The method according to claim 68, wherein the drying is carried out at 50° C. under vacuum.

70. The method according to claim 68, wherein the re-dissolving of the sulfonated copolymer is carried out at a temperature between 50 and 70° C. in methanol as a solvent.
